(19) United States
(12) Patent Application Publication
(10) Pub. No.: US 2024/0051359 A1
(43) Pub. Date: Feb. 15, 2024

(54) OBJECT POSITION ESTIMATION WITH CALIBRATED SENSORS

(71) Applicant: Ford Global Technologies, LLC, Dearborn, MI (US)

(72) Inventor: Kunle Olutomilayo, Newark, CA (US)

(73) Assignee: Ford Global Technologies, LLC, Dearborn, MI (US)

(21) Appl. No.: 17/819,331

(22) Filed: Aug. 12, 2022

(51) Int. Cl. B60D 1/36; B60R 1/00

(52) U.S. Cl. CPC B60D 1/36; B60R 1/003

(57) ABSTRACT

A system is disclosed that includes a computer that includes a processor and a memory, the memory including instructions executable by the processor to acquire a first image with a sensor, wherein the sensor is calibrated with a fiducial marker to determine a real world location of a reference plane. An image of an object is acquired with the sensor to determine that the object is located on the reference plane by determining object feature points. A location of the object is determined in real world coordinates including depth based on the object feature points. The system is operated based on the location of the object.

### BACKGROUND

Images can be acquired by sensors and processed using a computer to determine data regarding objects in an environment around a system. Operation of a sensing system can include acquiring accurate and timely data regarding objects in the system's environment. A computer can acquire images from one or more image sensors that can be processed to determine data regarding objects. Data extracted from images of objects can be used by a computer to operate systems including vehicles, robots, security systems, and/or object tracking systems.

### BRIEF DESCRIPTION OF THE DRAWINGS

FIG. 1 is a block diagram of an example traffic infrastructure system.

FIG. 2 is a diagram of an example traffic scene including a vehicle and a fiducial marker.

FIG. 3 is a diagram of an example traffic scene including a vehicle and an object.

FIG. 4 is a diagram of an example traffic scene including three reference planes.

FIG. 5 is a flowchart diagram of an example process to determine an object location.

FIG. 6 is a flowchart diagram of an example process to operate a vehicle based on an object location.

### DETAILED DESCRIPTION

A system as described herein can be used to locate objects in an environment around the system and operate the system based on the location of the objects. Typically, sensor data can be provided to a computer to locate an object and determine a system trajectory based on the location of the object. A trajectory is a set of locations that can be indicated as coordinates in a coordinate system that along with velocities, e.g., vectors indicating speeds and headings, at respective locations. A computer in a system can determine a trajectory for operating the system that locates the system or portions of the system with respect to the object. A vehicle is described herein as an example of a system that includes a sensor to acquire data regarding an object, a computer to process the sensor data and controllers to operate the vehicle based on output from the computer. Other systems that can include sensors, computers and controllers that can respond to objects in an environment around the system include robots, security systems and object tracking systems.

Sensors used to acquire image data that includes objects to be located can be acquired using fisheye lenses. Fisheye lenses can permit a sensor to acquire data from a wider field of view than rectilinear lenses, however, fisheye lenses introduce distortion into image data that can require additional processing to permit determining object locations in real world coordinates. Transforming fisheye lens images into rectilinear lens images may introduce potential discrepancies in the image data that may lead to potential discrepancies in object locations. Techniques described herein enhance determination of object locations using a reference plane and object feature points. Determining object locations using a reference plane and object feature points avoids transforming fisheye images into rectilinear images which reduces computing resources required to determine the object locations.

A method is disclosed herein, including acquiring a first image with a sensor, wherein the sensor is calibrated with a fiducial marker to determine a real world location of a reference plane, acquiring an image of an object with the sensor and determine that the object is located on the reference plane by determining object feature points, determining a location of the object in real world coordinates including depth based on the object feature points, and operating a system based on the location of the object. The location of the reference plane can be determined with sensor calibration parameters based on real world measurements of the fiducial marker. The object feature points can be determined using one or more of scale-invariant feature transform, speeded-up robust features, features from accelerated segment test, or binary robust independent elementary features. The depth can be based on a vertical distance between the sensor and the reference plane and is measured perpendicularly to the reference plane. The sensor can be calibrated by determining a homography matrix that transforms sensor pixel coordinates into real world coordinates on the reference plane.

The location of the object in the real world coordinates can be determined by applying the homography matrix to the object feature points. The object can be determined to be located on the reference plane based on comparing a first distance between the object feature points with a first previously determined distance between similar object feature points determined based on an image of the object located on the reference plane. When the object is determined to be located on a plane different than the reference plane, an offset between the object and the reference plane can be determined based on comparing a third distance between the object feature points with a fourth previously determined distance between similar object feature points determined based on the object located on the reference plane. The sensor can include a fisheye lens and determining the location of the object in the real world coordinates includes correcting for fisheye lens distortion parameters. The system can be a vehicle, the object is a trailer hitch, and operating the vehicle includes controlling one or more of vehicle powertrain, steering, and brakes to align a hitch ball with the trailer hitch. The system can be a robot, the object is a workpiece, and operating the robot includes controlling one or more moveable robot axes to align a robot gripper with the workpiece. A distance from an optical center of the sensor to the object can be determined by constructing a right triangle between the optical center and a point on the object and determining the length of a hypotenuse of the right triangle. The fisheye lens can be modeled by projecting points onto a unit sphere. The unit sphere can be projected onto a normalized plane to form camera intrinsic calibration parameters.

Further disclosed is a computer readable medium, storing program instructions for executing some or all of the above method steps. Further disclosed is a computer programmed for executing some or all of the above method steps, including a computer apparatus, programmed to acquire a first image with a sensor, wherein the sensor is calibrated with a fiducial marker to determine a real world location of a reference plane, acquire an image of an object with the sensor and determine that the object is located on the reference plane by determining object feature points, determine a location of the object in real world coordinates including depth based on the object feature points, and operate a system based on the location of the object. The location of the reference plane can be determined with sensor calibration parameters based on real world measurements of the fiducial marker. The object feature points can be determined using one or more of scale-invariant feature transform, speeded-up robust features, features from accelerated segment test, or binary robust independent elementary features. The depth can be based on a vertical distance between the sensor and the reference plane and is measured perpendicularly to the reference plane. The sensor can be calibrated by determining a homography matrix that transforms sensor pixel coordinates into real world coordinates on the reference plane.

The instructions can include further instructions to determine the location of the object in the real world coordinates by applying the homography matrix to the object feature points. The object can be determined to be located on the reference plane based on comparing a first distance between the object feature points with a first previously determined distance between similar object feature points determined based on an image of the object located on the reference plane. When the object is determined to be located on a plane different than the reference plane, an offset between the object and the reference plane can be determined based on comparing a third distance between the object feature points with a fourth previously determined distance between similar object feature points determined based on the object located on the reference plane. The sensor can include a fisheye lens and determining the location of the object in the real world coordinates includes correcting for fisheye lens distortion parameters. The system can be a vehicle, the object is a trailer hitch, and operating the vehicle includes controlling one or more of vehicle powertrain, steering, and brakes to align a hitch ball with the trailer hitch. The system can be a robot, the object is a workpiece, and operating the robot includes controlling one or more moveable robot axes to align a robot gripper with the workpiece. A distance from an optical center of the sensor to the object can be determined by constructing a right triangle between the optical center and a point on the object and determining the length of a hypotenuse of the right triangle. The fisheye lens can be modeled by projecting points onto a unit sphere. The unit sphere can be projected onto a normalized plane to form camera intrinsic calibration parameters.

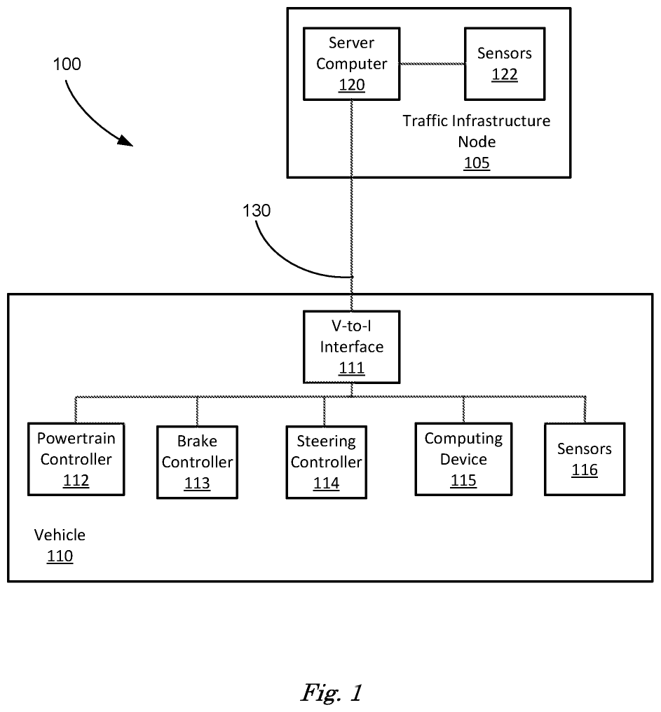

FIG. 1 is a diagram of a sensing system 100 that can include a traffic infrastructure node 105 that includes a server computer 120 and stationary sensors 122. Sensing system 100 includes a vehicle 110, operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a powertrain controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in autonomous, semi-autonomous, or manual modes. By a semi- or fully-autonomous mode, we mean a mode of operation wherein a vehicle can be piloted partly or entirely by a computing device as part of a system having sensors and controllers. For purposes of this disclosure, an autonomous mode is defined as one in which each of vehicle propulsion (i.e., via a powertrain including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer. In a semi-autonomous mode, some but not all of them are controlled by a computer.

A traffic infrastructure node 105 can include a physical structure such as a tower or other support structure (i.e., a pole, a box mountable to a bridge support, cell phone tower, road sign support, etc.) on which infrastructure sensors 122, as well as server computer 120, can be mounted, stored, and/or contained, and powered, etc. One traffic infrastructure node 105 is shown in FIG. 1 for ease of illustration, but the system 100 could and likely would include tens, hundreds, or thousands of traffic infrastructure nodes 105. The traffic infrastructure node 105 is typically stationary, i.e., fixed to and not able to move from a specific geographic location. The infrastructure sensors 122 may include one or more sensors such as described above for the vehicle 110 sensors 116, i.e., lidar, radar, cameras, ultrasonic sensors, etc. The infrastructure sensors 122 are fixed or stationary. That is, each sensor 122 is mounted to the infrastructure node so as to have a substantially unmoving and unchanging field of view.

Server computer 120 typically has features in common, i.e., a computer processor and memory and configuration for communication via a network 130, with the vehicle 110 V2X interface 111 and computing device 115, and therefore these features will not be described further to avoid redundancy. Although not shown for ease of illustration, the traffic infrastructure node 105 also includes a power source such as a battery, solar power cells, and/or a connection to a power grid. A traffic infrastructure node 105 server computer 120 and/or vehicle 110 computing device 115 can receive sensor 116, 122 data to monitor one or more objects. An “object,” in the context of this disclosure, is a physical, i.e., material, structure or thing that can be detected by a vehicle sensor 116 and/or infrastructure sensor 122.

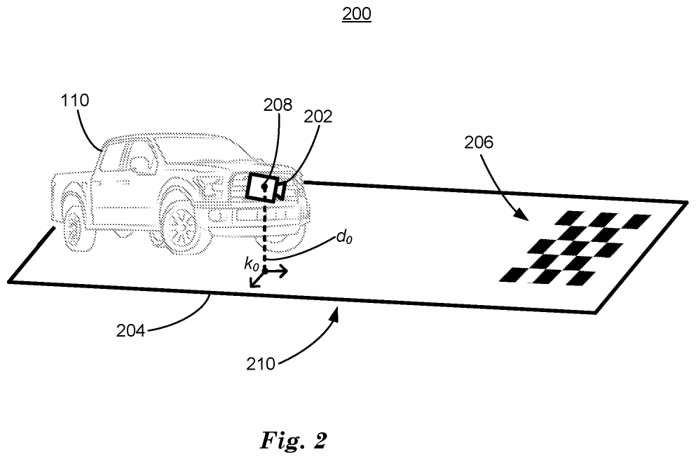

FIG. 2 is a diagram of a traffic scene 200. Traffic scene 200 includes a vehicle 110 as it operates on a supporting surface 204 which can be, for example, a roadway, a parking lot, or a floor or ground included in a parking garage or other structure. Vehicle 110 includes a video camera 202. As discussed above in relation to FIG. 1, a vehicle 110 can include a sensor 116, in this example a video camera 202 that acquires data regarding an environment around the vehicle 110. Vehicle 110 can include variety of sensors 116 including one or more of a lidar sensor, a radar sensor, or an ultrasound sensor to acquire data regarding an environment around the vehicle 110. A computing device 115 in the vehicle 110 can receive as input data acquired by video camera 202 and process the data to determine the location of a reference plane 210 that is coincident with the supporting surface 204 upon which the vehicle 110 is located. A reference plane 210 can be described by an equation of the form P=ax+by +c that defines a plane that approximates the supporting surface 204.

A computing device 115 in a vehicle 110 can use a fiducial marker 206 located on the supporting surface 204 to determine the location of a reference plane 210 based on real world measurements of a fiducial marker 206. In this example, fiducial marker 206 is a checkerboard pattern. The real world location of fiducial marker 206 can be determined with sensor calibration parameters, in this example video camera 202 calibration parameters. Sensor 116 can be a video camera 202 that includes a fisheye lens. A fisheye lens is a wide angle lens that increases the field of view of a video camera over a standard rectilinear lens while distorting straight lines into curves. Acquiring an image with a fisheye camera can be described mathematically as first projecting world coordinates, i.e., global coordinates included in a real-world traffic scene, into camera coordinates, i.e., coordinates measured relative to the camera sensor plane:

$$[ \begin{matrix}{X}_{C} \\ {Y}_{C} \\ {Z}_{C}\end{matrix} ] = {R}_{W} [ \begin{matrix}{X}_{W} \\ {Y}_{W} \\ {Z}_{W}\end{matrix} ] + {t}_{W} \qquad ( 1 )$$

In Equation 1, X_{W}, Y_{W}, Z_{W} are the three axis coordinates of a point in real-world coordinates, X_{C}, Y_{C}, Z_{C} are the three axis coordinates of a point in camera coordinates, R_{W} is a 3×3 rotational matrix that rotates a point in three-dimensional space and t_{W} is a 3×1 matrix that translates a point in three-dimensional space. Imaging a point in three-dimensional space with a fisheye lens can be modeled as projecting the point onto a unit sphere by the following equation:

$$[ \begin{matrix}{X}_{S} \\ {Y}_{S} \\ {Z}_{S}\end{matrix} ] = [ \begin{matrix}\frac{{X}_{C}}{\sqrt{{X}_{C}^{2} + {Y}_{C}^{2} + {Z}_{C}^{2}}} \\ \frac{{Y}_{C}}{\sqrt{{X}_{C}^{2} + {Y}_{C}^{2} + {Z}_{C}^{2}}} \\ \frac{{Z}_{C}}{\sqrt{{X}_{C}^{2} + {Y}_{C}^{2} + {Z}_{C}^{2}}}\end{matrix} ] \qquad ( 2 )$$

In Equation 2, Xₛ, Yₛ, Zₛ are the three axis coordinates of a point projected on to the unit sphere. The point on the unit sphere is then projected onto a normalized plane to yield normalized coordinates x_{ud}, y_{ud} by the equation:

$$[ \begin{matrix}{x}_{ud} \\ {y}_{ud}\end{matrix} ] = [ \begin{matrix}\frac{{X}_{S}}{{Z}_{S} + ξ} \\ \frac{{Y}_{S}}{{Z}_{S} + ξ}\end{matrix} ] \qquad ( 3 )$$

Distortion parameters related to the fisheye lens distortion k₁, k₂, p₁, p₂, can be estimated by determining the intrinsic calibration of the fisheye lens and used to correct for fisheye lens distortion. Intrinsic calibration includes the parameters (e.g., specified by a camera manufacturer) that determine the fisheye lens distortion that occurs in addition to the distortion due to the spherical lens. The fisheye lens distortion parameters are applied to the normalized coordinates to transform the undistorted coordinates x_{ud}, y_{ud} to distorted coordinates x_{d}, y_{d}:

$$[ \begin{matrix}{x}_{d} \\ {y}_{d}\end{matrix} ] = [ \begin{matrix}{x}_{ud} ( 1 + {k}_{1} ( {x}^{2} + {y}^{2} ) + {{k}_{2} ( {x}^{2} + {y}^{2} )}^{2} ) + 2 {p}_{1} {x}_{ud} {y}_{ud} + {p}_{2} ( ( {x}^{2} + {y}^{2} ) + 2 {x}^{2} ) \\ {y}_{ud} ( 1 + {k}_{1} ( {x}^{2} + {y}^{2} ) + {{k}_{2} ( {x}^{2} + {y}^{2} )}^{2} ) + 2 {p}_{2} {x}_{ud} {y}_{ud} + {p}_{1} ( ( {x}^{2} + {y}^{2} ) + 2 {x}^{2} )\end{matrix} ] \qquad ( 4 )$$

A generalized camera projection matrix that converts the distorted, normalized fisheye coordinates into camera coordinates

$$p = [ \begin{matrix}\tilde{u} \\ \tilde{v}\end{matrix} ]$$

using camera parameters for focal length fₓ, f_{y} in x and y, optical center cₓ, c_{y} in x and y and skew s:

$$p ≡ [ \begin{matrix}\tilde{u} \\ \tilde{v} \\ 1\end{matrix} ] = [ \begin{matrix}{f}_{s} & s & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ] \qquad ( 5 )$$

Applying equations (1)-(5) to real world coordinates X_{W}, Y_{W}, Z_{W} can yield camera coordinates p, i.e., applying equations (1)-(5) to a real world traffic scene 200 can yield a fisheye image. This is summarized by the equation:

F(p)=Π(Ø) (6)

where F(p) is a fisheye image, Π is the transform that includes equations (1)-(5) and Ø is a set of data points in three-dimensional real-world coordinates. The intrinsic camera calibration parameters in equation (5) and the distortion parameters in equation (4) can be determined by acquiring images of patterns such as grid patterns and comparing the original pattern to the image of the pattern acquired with the fisheye lens.

The intrinsic camera calibration parameters and distortion parameters obtained in this fashion can be used with an image of a fiducial marker 206 to determine the depth d of a point k₀ with respect to reference plane 210. The depth d of the point k₀ is based on the vertical distance between the optical center 208 of video camera 202 and the reference plane 210 and is measured perpendicularly to the reference plane 210. The locations of the one or more points on the fiducial marker 206, for example the four corner points of the fiducial marker 206, can be measured in the real world with respect to an optical center 208 of video camera 202. Equations (1) to (5) above can be inverted to yield n (1<i<n) undistorted pixels (ũᵢ, \tilde{v}ᵢ) having real world coordinates locations x_{wi}, y_{wi}, z_{wi} with the coordinates system origin at k₀. The perspective projection matrix P∈ [symbol] ^{3×3} for z_{wi}=0, i.e., assuming that the fiducial marker 206 is in the same plane as k₀ relates the undistorted pixels (ũᵢ, \tilde{v}ᵢ) and the plane (x_{w}_{ᵢ}, y_{w}_{ᵢ}):

$$[ \begin{matrix}{\tilde{u}}_{i} \\ {\tilde{v}}_{i} \\ 1\end{matrix} ] ≡ P [ \begin{matrix}{x}_{wi} \\ {y}_{wi} \\ 1\end{matrix} ] \qquad ( 7 )$$

A homography matrix H, taken as an inversion of P, can be defined which transforms undistorted pixels (ũᵢ, \tilde{v}ᵢ) from image space to real world coordinates based on the measured locations of the real world coordinates of the corners of the fiducial marker 206 according to the equation:

$$s [ \begin{matrix}{x}_{wi} \\ {y}_{wi} \\ 1\end{matrix} ] = H [ \begin{matrix}{\tilde{u}}_{i} \\ {\tilde{v}}_{i} \\ 1\end{matrix} ] \qquad ( 8 )$$

Where s is a scalar that can be determined by normalizing the third dimension to 1 to obtain an estimate for

$$[ \begin{matrix}{x}_{w i} \\ {y}_{w i} \\ 1\end{matrix} ] .$$

Once the homography matrix H and scalar s are determined, the real world coordinates (x_{w}, y_{w}) of any point in a fisheye image that can be assumed to lie in reference plane 210 can be obtained using the homography matrix H and applying it to the undistorted pixel coordinates (ũ, \tilde{v}) of the point to transform sensor pixel locations into the real world coordinate locations on the reference plane 210.

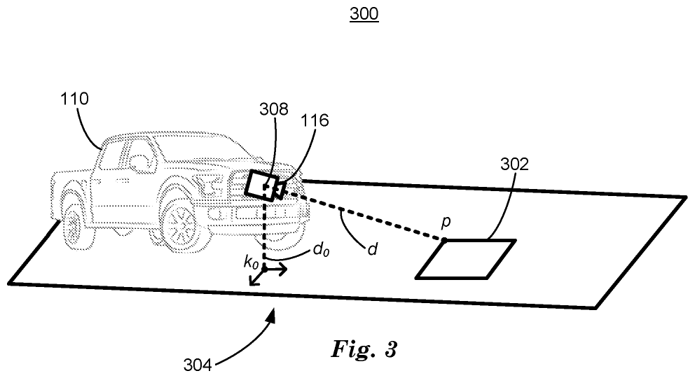

FIG. 3 is a diagram of a traffic scene 300 that includes a vehicle 110 having a sensor 116. The distance do between the optical center 308 of the sensor 116 and a point k₀ on the reference plane 304 has been determined as discussed above in relation to FIG. 2. The real world coordinates (ũₚ, \tilde{v}ₚ) of a point p on an object 302 lying on reference plane 304 can be determined based on homography matrix H, and s determined as discussed above in relation to FIG. 2. The distance d from the optical center 308 of sensor 116 can be determined by constructing a right triangle between optical center 308, point k₀, and point p and using trigonometry to determine length of the hypotenuse d.

Points on an object 302 included in a fisheye lens image including point p can be determined using image processing techniques. Image processing techniques that can determine one or more points on and object 302 include known techniques such as scale-invariant feature transform (SIFT), speeded-up robust features (SURF), features from accelerated segment test (FAST), and binary robust independent elementary features (BRIEF). SIFT is described in “Object recognition from local scale-invariant features”, Lowe, David G., Proceedings of the International Conference on Computer Vision. Vol. 2. pp. 1150-1157 (1999). SURF is described in, “Speeded Up Robust Features”, Herbert Bay, Andreas Ess, Tinne Tuytelaars, and Luc Van Gool, ETH Zurich, Katholieke Universiteit Leuven. FAST is described in “Machine Learning for High-Speed Corner Detection”, Edward Rosten and Tom Drummond, ECCV 2006, pp. 440-443. BRIEF is described in “BRIEF: Binary Robust Independent Elementary Features”, Michael Calonder, Vincent Lepetit, Christoph Strecha, and Pascal Fua, ECCV 2010, pp. 778-792. Feature point detectors such as SIFT, SURF, FAST, and BRIEF determine locations or points in an image by processing neighborhoods of pixels to detect edges, corners, or other changes in pixel values. Feature point detectors can determine the same locations on an object despite changes in illumination or orientation of the object.

In an example of techniques described herein, a vehicle 110 can be operated using one or more of map data, GPS data and IMU data to approach a parking space in a parking lot or parking structure that includes a charging outlet. Data regarding the location of the charging outlet can be required with higher resolution than that included in the map data. For example, map data can include the location of the charging outlet, typically to within +/−10 cm. In order to plug a vehicle 110 into a charging outlet automatically, the charging outlet may require alignment to within a greater degree of precision than provided by the map data, to within +/−1 cm, for example. Object detection using a reference plane 304 as described herein can locate a charging outlet with the required accuracy reliably and quickly using computing resources available in a vehicle 110. Object detection using a reference plane as described herein enhances object detection for fisheye lens data by not requiring sensor intrinsic parameters to transform an entire image of pixel data from fisheye lens data to an image that includes rectilinear data. By not requiring sensor intrinsic parameters to transform an entire image of pixel data from fisheye lens data to rectilinear data, object detection using a reference plane avoids potential discrepancies in object location. Sensor intrinsic parameters are parameters that include focal length, sensor size and location, and lens distortion as discussed above in relation to FIG. 2.

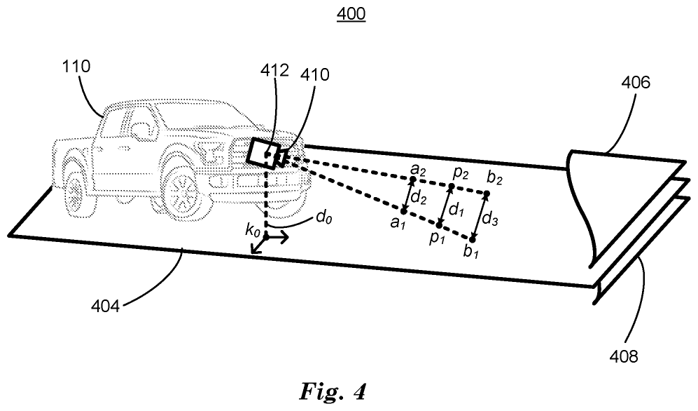

FIG. 4 is a diagram of a traffic scene 400 including a vehicle 110. Vehicle 110 is supported on a roadway or pavement. A first reference plane 404 can be located with respect to video camera 410 using techniques discussed above in relation to FIGS. 2 and 3 to determine the location of point k₀ and distance d₀. In examples of object location based on reference plane location, the object can be located on second reference plane 406 located above the first reference plane 404 or located on a third reference plane 408 located below the first reference plane 404. An example of an object located above a first reference plane 404 is a trailer hitch. A trailer hitch is the portion of a trailer that attaches the trailer to a towing vehicle by positioning the trailer hitch onto a hitch ball attached to the towing vehicle.

To locate a trailer hitch using object location based on reference plane location, a rear-facing sensor 116, which can be a video camera, included in a vehicle will be calibrated by determining the location of a point k₀ and distance d₀ with respect to the sensor 116. The location of the sensor 116 with respect to the vehicle 110 and the surface that supports the vehicle 110 can be measured at the time the camera is installed in the vehicle 110 to determine the three-dimensional distance from the sensor 116 to a hitch ball installed on the vehicle 110. The object location with respect to the vehicle 110 can be based on a reference plane determined to be coincident with the surface that supports the vehicle 110.. The location of the reference plane with respect to the vehicle 110 can be determined as discussed above in relation to FIG. 2 and stored in a computing device 115 included in the vehicle 110. The computing device 115 can acquire sensor data, locate the trailer hitch in 3D space and determine a trajectory that can be used to move vehicle 110 to a location where the trailer hitch can be lowered onto the hitch ball to attach the trailer to the vehicle.

Objects such as trailer hitches are typically not located on a first reference plane that is coincident with a roadway or pavement that supports the vehicle 110. A new (or second) reference plane can be determined based on measuring a distance d 1 illustrated in FIG. 4 and comparing it to similar object feature points determined on an object included in a newly acquired image. Similar object feature points can be determined by processing a newly acquired image with the same image processing technique(s) that determined the feature points used to determine the first distance d₁. Distance d₁ is measured between points p₁ and p₂ on an object such as a trailer hitch when it is located in a first reference plane. Distance d₁ can be measured between points p₁ and p₂ on an object such as a trailer hitch at manufacturing time or any time prior to using the object location system. Points p₁ and p₂ can be determined by processing an image of the object using feature point detection as discussed above in relation to FIG. 3. As discussed above, feature detection techniques tend to determine the same points on similar images. Similar images are images that include the same objects oriented at angles that are within a few degrees, for example +/−45 degrees under lighting conditions that include lighting contrast on the object within +/−50%. Points p₁ and p₂ can also be generated by attaching a fiducial marker to the object to increase a probability that the feature point detection will detect the same points each time the object is viewed.

A distance d₁ can be measured between points p₁ and p₂ on an object located in a first reference plane 404 and the distance d₁ stored in memory included in computing device 115. During operation of the object location system, a sensor 116 included in a vehicle 110 can acquire an image of the object to be located and execute the same feature point detection that previously located points p₁ and p₂. The feature point detection can locate two new points, illustrated in FIG. 4 as points a₁ and a₂ and points b₁ and b₂. A new distance measure between the two new points can be determined. For example, points a₁ and a₂ yield the distance d₂ and points b₁ and b₂ yield the distance d₃. Comparing a distance d₂, d₃ measured on the newly acquired points a₁ and a₂ and points b₁ and b₂ can determine whether the new reference plane is above or below the first reference plane by comparing a distance d₂, d₃ with a previously determined distance d₁ stored in memory. When a distance d₂ is less than distance d₁, the second reference plane 406 that includes the object is determined to be located above the first reference plane 404. When a distance d₃ is greater than distance d₁ the third reference plane 408 that includes the object is determined to be located below the first reference plane 404.

When it is determined that a measured distance d₂, d₃, constructing a right triangle that includes a portion of the distance d₀, the optical center 412 of the video camera 410 and either points a₁ and a₂ or points b₁ and b₂ depending upon the measured distance d₂ or d₃ can determine the offset of the location of the new reference plane 406, 408 with respect to the first reference plane 404. When the location offset of the new reference plane 406, 408 is determined, the object location system can determine the location of the object in 3D world coordinates with respect to point k₀ by applying the offset to the calculations and projecting the location onto the first reference plane 404. In this fashion, the object location system using a reference plane can determine the location of objects that are not located on the reference plane.

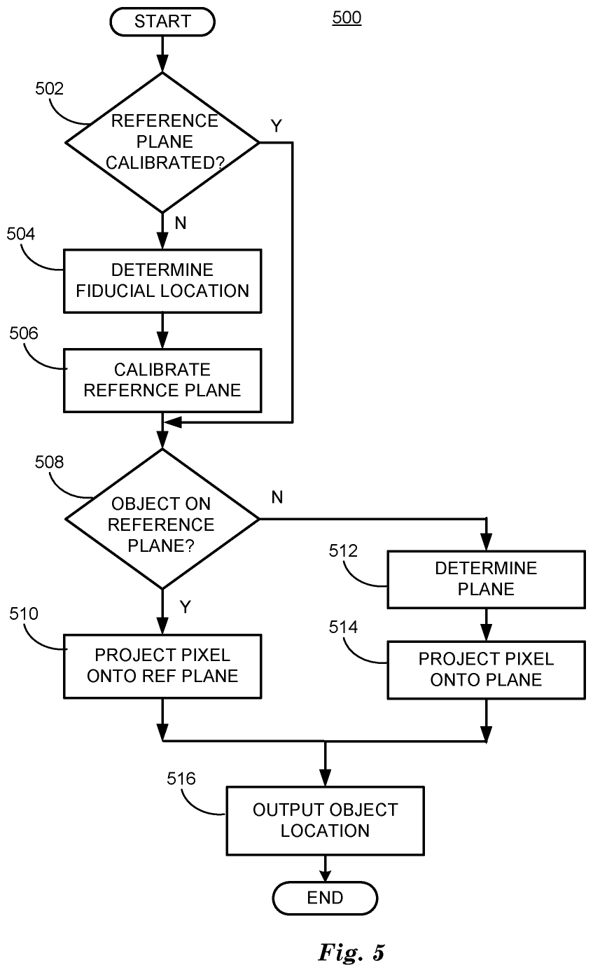

FIG. 5 is a flowchart, described in relation to FIGS. 1-4 of a process 500 for calibrating and operating a system for locating objects using a reference plane. Process 500 can be implemented by a processor of a computing device 115, taking as input images acquired from a sensor 116, executing commands, and outputting a 3D object location in real world coordinates. Process 500 includes multiple blocks that can be executed in the illustrated order. Process 500 could alternatively or additionally include fewer blocks or can include the blocks executed in different orders.

Process 500 begins at block 502, where process 500 determines whether the object location system is calibrated. The object location system is calibrated when the distance d₀ from a sensor 116 to a first reference plane 404 has been determined and stored in the memory of the computing device 115. In examples where the object to be located can occur in reference planes that differ from the first reference plane 404, calibrating the system can include determining two or more feature points p₁, p₂ by executing feature point detection on the image data as discussed above in relation to FIGS. 3 and 4 to determine a distance d₁. If the object location system is not calibrated, process 500 passes to block 504. If the object location system is calibrated, process 500 passes to block

At block 504 the object location system acquires an image of a fiducial marker located on a reference plane. In examples where the object to be located can occur at locations that are not on the reference plane, an image of the object located on the reference plane is also acquired.

At block 506 process 500 determines the location of a point k₀ and a distance d₀ with respect to a sensor 116 included in the vehicle 110 based on the acquired fiducial marker image. In examples where the object to be located can occur in reference planes that differ from the first reference plane 404, two or more feature points p₁, p₂ are determined by executing feature point detection on the image of the object located on the reference plane 404 as discussed above in relation to FIGS. 3 and 4 to determine a distance d₁.

At block 508 process 500 determines whether the object is located on the reference plane by acquiring an image of the object, executing feature point detection and comparing a measured distance d₂, d₃ on the object to the stored distance d₁ to determine whether the object is on the reference plane 404. If the measured distance d₂, d₃ on the object is the same as distance d₁, the object is located on the reference plane 404 and process 500 passes to block 510. If the measured distance d₂, d₃ on the object is the different than distance d₁, the object is not located on the reference plane 404 and process 500 passes to block 512.

At block 510 a feature point located on the object using feature point detection is projected onto the reference plane 404 and the distance to points k₀ and a distance d₀ are determined in real world coordinates by constructing a right triangle as discussed above in relation to FIG. 3 and determining the length of the hypotenuse.

At block 512, the object is not located on the reference plane 404, so the measured distance d₂, d₃ is compared to the stored distance d₁ to determine the location of a second or third reference plane 406, 408 as discussed above in relation to FIG. 4, above.

At block 514 a feature point located on the object using feature point detection is projected onto the second or third reference plane 406, 408 determined at block 512, above to determine the location of the object in 3D real world coordinates.

At block 516 the location of the object in 3D real world coordinates is output to computing device 115. Following block 516 process 500 ends.

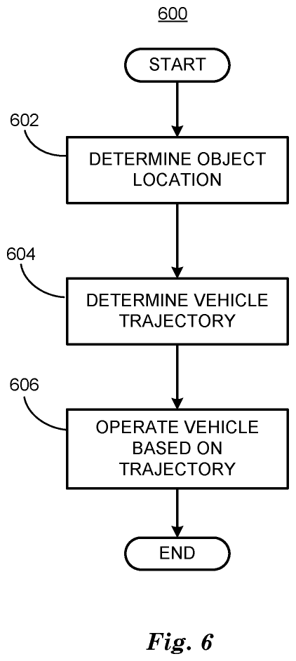

FIG. 6 is a flowchart, described in relation to FIGS. 1-5 of a process 7600 for operating a vehicle 110 based on locating an object in 3D real world coordinates using a reference plane. Process 600 can be implemented by a processor of a computing device 115, taking as input image data that includes an object, executing commands, and operating a vehicle 110. Process 600 includes multiple blocks that can be executed in the illustrated order. Process 600 could alternatively or additionally include fewer blocks or can include the blocks executed in different orders.

At block 602 process 600 determines a 3D real world location of an object with an object location system using a reference plane as described in FIGS. 1-5, above. The examples in FIGS. 1-5 describe an object location system included in a vehicle 110, however, the object location system using a reference plane can be used for robot guidance, surveillance, or object handling systems.

At block 604 process 600 determines a trajectory for operating a vehicle 110 based on the 3D real world location of the object determined at block 602. For example, a vehicle 110 can detect the 3D real world location of a charging outlet and determine a trajectory that would position the charging port of the vehicle adjacent to the charging outlet. In another example the vehicle can detect the 3D real world location of a trailer hitch and determine a trajectory that would position a hitch ball located on the vehicle adjacent to the trailer hitch. In examples where the object location system is included in a robot, the trajectory can position a robot's gripper adjacent to a workpiece by controlling moveable robot axes to align the robot gripper with the workpiece. In an example where the object location system was included in a surveillance system, the object can be a human and the surveillance system can determine whether a human is permitted to perform a determined trajectory, i.e., enter a certain area.

At block 606 process 600 operates the vehicle 110 based on the determined trajectory. Operating a vehicle 110 can include communicating commands from computing device 115 to controllers 112, 113, 114 to control one or more of vehicle powertrain, steering, and brakes to position the vehicle 110 in the appropriate position with respect to the located object. In the example of a robot, computing device 115 can communicate commands to actuators that control a robotic arm and end effectors such as a gripper to grasp a workpiece. In the example of a surveillance system the surveillance system could sound an alarm based on detecting a forbidden trajectory by a human. Following block 606 process 600 ends

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
acquire a first image with a sensor, wherein the sensor is calibrated with a fiducial marker to determine a real world location of a reference plane;
acquire an image of an object with the sensor and determine that the object is located on the reference plane by determining object feature points;
determine a location of the object in real world coordinates including depth based on the object feature points; and
operate the system based on the location of the object.

2. The system of claim 1, wherein the location of the reference plane is determined with sensor calibration parameters based on real world measurements of the fiducial marker.

3. The system of claim 1, the instructions including further instructions to determine the object feature points using one or more of scale-invariant feature transform, speeded-up robust features, features from accelerated segment test, or binary robust independent elementary features.

4. The system of claim 1, wherein the depth is based on a vertical distance between the sensor and the reference plane and is measured perpendicularly to the reference plane.

5. The system of claim 1, the instructions including further instructions to calibrate the sensor by determining a homography matrix that transforms sensor pixel coordinates into real world coordinates on the reference plane.

6. The system of claim 5, the instructions including further instructions to determine the location of the object in the real world coordinates by applying the homography matrix to the object feature points.

7. The system of claim 1, the instructions including further instructions to determine that the object is located on the reference plane based on comparing a first distance between the object feature points with a second previously determined distance between similar object feature points determined based on an image of the object located on the reference plane.

8. The system of claim 1, the instructions including further instructions to, when the object is determined to be located on a plane different than the reference plane, determining an offset between the object and the reference plane based on comparing a third distance between the object feature points with a fourth previously determined distance between similar object feature points determined based on the object located on the reference plane.

9. The system of claim 1, wherein the sensor includes a fisheye lens and determining the location of the object in the real world coordinates includes correcting for fisheye lens distortion parameters.

10. The system of claim 1, wherein the system is a vehicle, the object is a trailer hitch, and operating the vehicle includes controlling one or more of vehicle powertrain, steering, and brakes to align a hitch ball with the trailer hitch.

11. The system of claim 1, wherein the system is a robot, the object is a workpiece, and operating the robot includes controlling one or more moveable robot axes to align a robot gripper with the workpiece.

12. A method, comprising:
acquiring a first image with a sensor, wherein the sensor is calibrated with a fiducial marker to determine a real world location of a reference plane;
acquiring an image of an object with the sensor and determine that the object is located on the reference plane by determining object feature points;
determining a location of the object in real world coordinates including depth based on the object feature points; and
operating a system based on the location of the object.

13. The method of claim 12, wherein the location of the reference plane is determined with sensor calibration parameters based on real world measurements of the fiducial marker.

14. The method of claim 12, further comprising determining the object feature points using one or more of scale-invariant feature transform, speeded-up robust features, features from accelerated segment test, or binary robust independent elementary features.

15. The method of claim 12, wherein the depth is based on a vertical distance between the sensor and the reference plane and is measured perpendicularly to the reference plane.

16. The method of claim 12, further comprising calibrating the sensor by determining a homography matrix that transforms sensor pixel coordinates into real world coordinates on the reference plane.

17. The method of claim 16, further comprising determining the location of the object in the real world coordinates by applying the homography matrix to the object feature points.

18. The method of claim 12, further comprising determining that the object is located on the reference plane based on comparing a first distance between the object feature points with a first previously determined distance between similar object feature points determined based on an image of the object located on the reference plane.

19. The method of claim 12, further comprising, when the object is determined to be located on a plane different than the reference plane, determining an offset between the object and the reference plane based on comparing a third distance between the object feature points with a fourth previously determined distance between similar object feature points determined based on the object located on the reference plane.

20. The method of claim 12, wherein the sensor includes a fisheye lens and determining the location of the object in the real world coordinates includes correcting for fisheye lens distortion parameters.
